(19) United States
(12) Patent Application Publication
(10) Pub. No.: US 2014/0362586 A1
(43) Pub. Date: Dec. 11, 2014

(54) LED LIGHT BULB

(71) Applicant: NAN YA PHOTONICS INC., Taipei City (TW)

(72) Inventor: Bor-Jen WU, Taipei City (TW)

(73) Assignee: NAN YA PHOTONICS INC., Taipei City (TW)

(21) Appl. No.: 14/027,390

(22) Filed: Sep. 16, 2013

(30) Foreign Application Priority Data
Jun. 11, 2013 (TW) 102210953

(51) Int. Cl. F21V 9/16

(52) U.S. Cl. CPC F21V 9/16
USPC 362/311.02

(57) ABSTRACT

The present invention relates to a LED light bulb, which at least includes: a bulb base; an insulation part formed with an accommodation space; a power module disposed in the accommodation space and electrically connected to the bulb base; a support post; a light source module disposed on top of the support post and electrically connected to the power module, and including a light-pervious substrate and plural lighting units, the periphery and the top of the lighting unit and the backside of the light-pervious substrate defined at the lighting unit and the periphery of the lighting unit are further provided with a phosphor coating; and a lampshade configured to transmit light originating from the blue light source module.

Accordingly, the LED light bulb provided by the present invention can achieve the omnidirectional output.

### BACKGROUND OF THE INVENTION

1. Field of the Invention:

The present invention relates to a LED light bulb, especially to a LED light bulb in which a light source module is disposed on top of a support post, and the light source module includes a light-pervious substrate and plural lighting units annularly arranged at the outer side of the substrate, and the periphery and the top of the lighting unit and the backside of the light-pervious substrate defined at the lighting unit and the periphery of the lighting unit are further provided with a phosphor coating, thereby achieving the omnidirectional output.

2. Description of Related Art:

Since Thomas Alva Edison invented the light bulb, a.k.a. bulb-shaped lamp, a tungsten filament has been used as the lighting unit. Because the tungsten filament is a module which outputs light in an omnidirectional manner, there is no certain direction in which more light may be outputted, other conventional modules such as a candle or kerosene lamp are therefore replaced. At present, a light source having omnidirectional output is commonly seen in the marketplace.

However, a light bulb adopting the tungsten filament as the light source module consumes more power, i.e. the power consumed for each watt can only provide relatively-lower luminance. As a result, many illumination units consuming less power and being energy efficient are developed for replacing the conventional tungsten light bulb.

Among the available illumination units, the LED consumes minimum power thereby being known as the electric illumination product complying with green energy. However, a LED module can only emit pointy light source and has directivity while being compared with the conventional module, so how to enjoy the advantage of low power consumption and diffuse the pointy light source for being applicable as an illumination lamp shall be seriously concerned.

The LED has been adopted in a light bulb and many relevant products are available in the marketplace. The main stream is to design the appearance of a LED light bulb to be similar to a conventional tungsten light bulb and to adopt the same connector.

Referring to FIG. 1, which is a perspective view illustrating the LED light bulb disclosed in the China Patent Application NO. CN103016991A. As shown in FIG. 1, the LED light bulb disclosed in the China Patent Application NO. CN103016991A mainly includes LED filaments 100 and an insertion seat 110, wherein the LED filaments 100 are respectively inserted in the insertion seat 110, and at least one LED filament 100 is obliquely arranged with an angle θ. The insertion seat 110 is fastened on a metal column of a glass core post 120, the glass core post 120 is sintered with a light bulb shell 130.

The mentioned LED light bulb has following disadvantages: when being assembled, the plural LED filaments 100 are required to be respectively inserted in the insertion seat 110, and at least one LED filament 100 is obliquely arranged with an angle 0, the column-like light emitted by the LED filaments 100 is required to be rearranged, stacked for forming the ball-like light so as to satisfy the omnidirectional output, however, the rearranging and stacking process is complicated, the production cost is therefore increased.

Accordingly, designing a novel LED light bulb for overcoming the mentioned disadvantages is necessary.

### SUMMARY OF THE INVENTION

One primary objective of the present invention is to provide a LED light bulb, in which a light source module is disposed on top of a support post, and the light source module includes a light-pervious substrate and plural lighting units, the periphery and the top of the lighting unit and the backside of the light-pervious substrate defined at the lighting unit and the periphery of the lighting unit are further provided with a phosphor coating, thereby achieving the omnidirectional output.

Another objective of the present invention is to provide a LED light bulb, which includes: a bulb base; an insulation part disposed on the bulb base and formed with an accommodation space; a power module disposed in the accommodation space and electrically connected to the bulb base; a support post disposed on the insulation part; a light source module disposed on top of the support post and electrically connected to the power module, and including a light-pervious substrate and plural lighting units, the periphery and the top of the lighting unit and the backside of the light-pervious substrate defined at the lighting unit and the periphery of the lighting unit are further provided with a phosphor coating; and a lampshade configured to transmit light originating from the light source module.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view illustrating the LED light bulb disclosed in the China

FIG. 2 is an exploded view illustrating the LED light bulb according to one preferred embodiment of the present invention;

FIG. 3 is a cross sectional view illustrating the assembly of the LED light bulb according to one preferred embodiment of the present invention;

FIG. 4 is a schematic view illustrating the omnidirectional output of the LED light bulb according to one preferred embodiment of the present invention;

FIG. 5 is a perspective view illustrating the LED light bulb according to one preferred embodiment of the present invention; and

FIG. 6 is a perspective view illustrating the LED light bulb according to another preferred embodiment of the present invention.

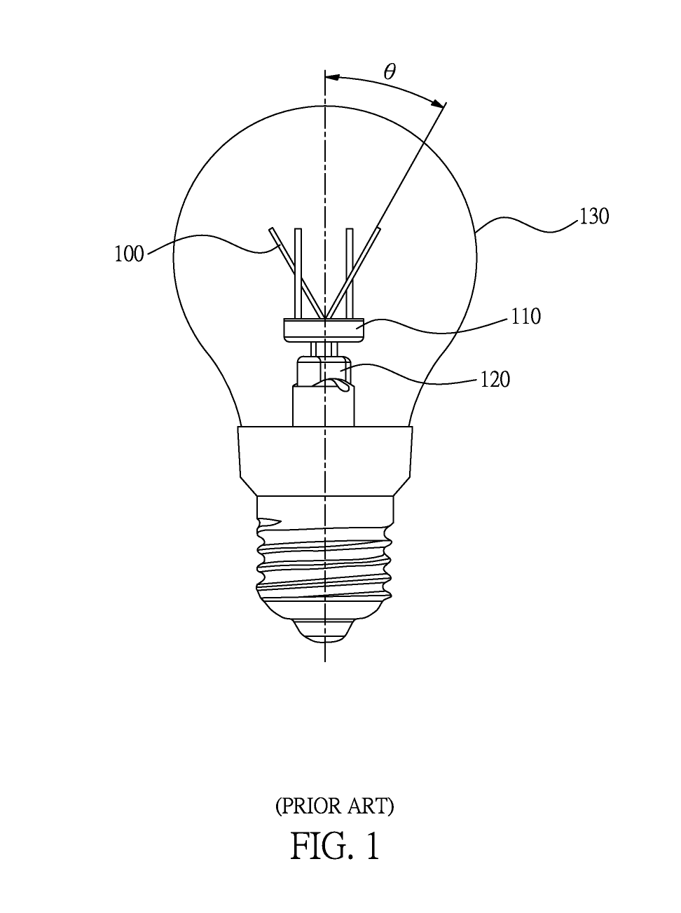

### DETAILED DESCRIPTION OF THE PREFERRED EMBODIMENT

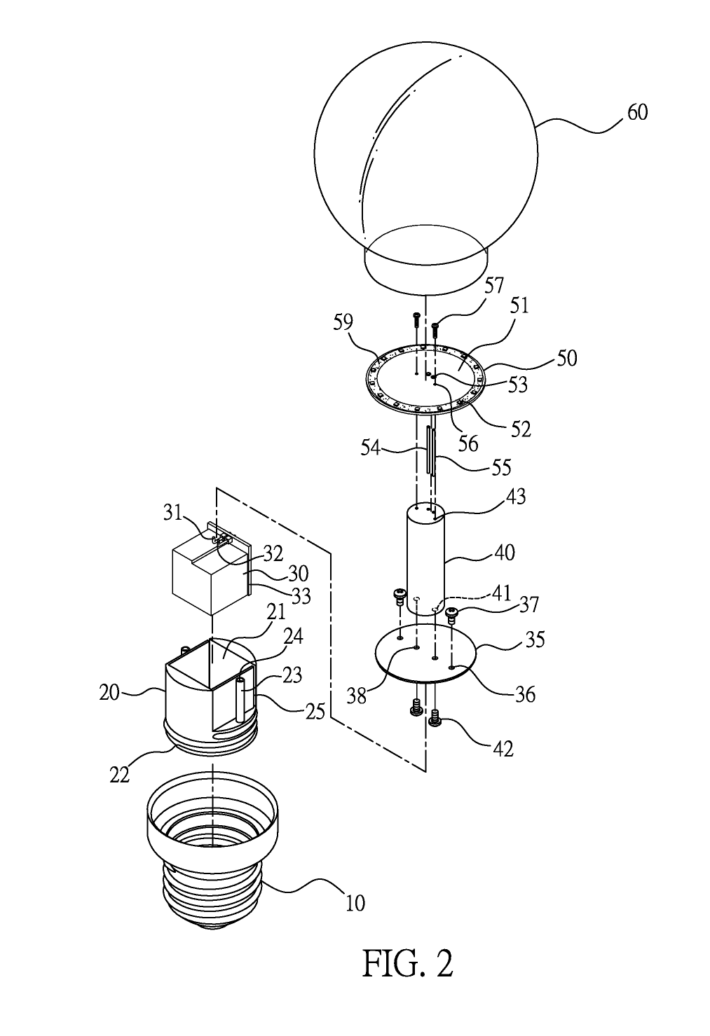

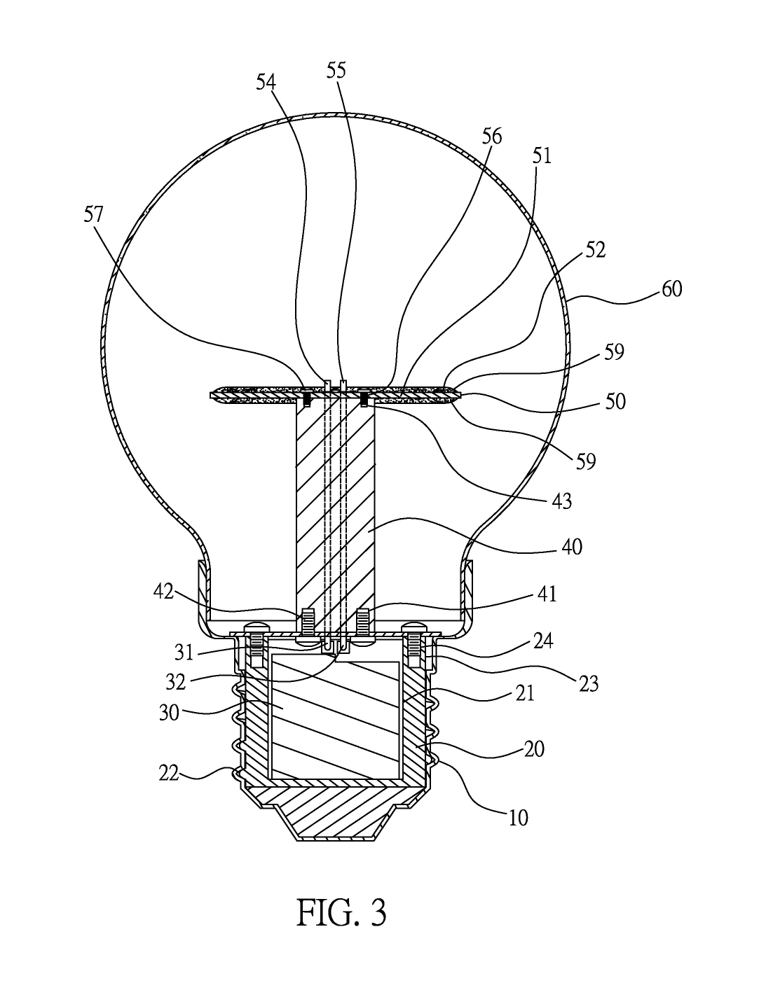

Referring from FIG. 2 and FIG. 3, wherein FIG. 2 is an exploded view illustrating the LED light bulb according to one preferred embodiment of the present invention; and FIG. 3 is a cross sectional view illustrating the assembly of the LED light bulb according to one preferred embodiment of the present invention.

As shown in figures, the LED light bulb provided by the present invention at least includes: a bulb base 10, an insulation part 20, a power module 30, a support post 40, a light source module 50 and a lampshade 60.

The bulb base 10 is e.g. but not limited to an E26/E27/B22 connector. If being applied in a small LED light bulb, an E12 connector used in a small nightlight can be adopted. If being applied in a large illumination lamp, an E40 connector can be adopted. According to one embodiment of the present invention, an E27 connector is adopted for illustration and shall not be a limitation to the scope of the present invention.

The insulation part 20 is disposed on the bulb base 10, formed as e.g. but not limit to a hollow barrel-shaped structure, and formed with an accommodation space 21, the bottom thereof is formed with a thread 22 for being screw-fitted in the bulb base 10, two sides thereof are respectively formed with a fasten post 23, the top end of the fasten post 23 is formed with a fasten hole 24. Wherein, the insulation part 20 is made of a plastic material. In addition, a slide groove 25 is respectively formed between the two fasten posts 23 of the insulation part 20. Moreover, the insulation part 20 can be served to insulate the power module 30 thereby complying with relevant safety regulations.

The power module 30 is disposed in the accommodation space 21 and electrically connected to the bulb base 10, the top end thereof is formed with a first metal pin 31 and a second metal pin 32 used for applying the electric power required by the light source module 50. In addition, two sides of the power module 30 are respectively formed with a side strip 33 for being received and fastened in the slide groove 25.

In addition, a pad 35 can further be provided on top of the insulation part 20, the pad 35 is fastened on the insulation part 20, and respectively formed with a first lock hole 36 corresponding to the fasten hole 24, so screws 37 can be provided for passing the first lock holes 36 for locking the pad 35 and the fasten hole 24. Moreover, the pad 35 is respectively formed with a second lock hole 38 at the inner side of each of the first lock holes 36.

The support post 40 is e.g. but not limited to be made of a metal material, and respectively formed with a first connection hole 41 corresponding to the second lock hole 38, so screws 42 can be provided for passing the second lock hole 38 for locking the support post 40 on the pad 35. The support post 40 is not only served to support the light source module 50, but also served to provide a heat dissipating effect to the light source module 50. Moreover, the top end of the support post 40 is further formed with at least a second connection hole 43.

The light source module 50 is disposed on top of the support post 40 and electrically connected to the power module 30, and includes a light-pervious substrate 51 and plural lighting units 52, the lighting unit 52 is e.g. but not limited to a LED chip, and preferably to be a blue LED chip or chip on board (COB) LED unit, and e.g. but not limited to be annularly arranged at the outer side of the light-pervious substrate 51; according to this embodiment, the means of annularly arranging the plural lighting units 52 at the outer side of the light-pervious substrate 51 is provided for illustration and shall not be a limitation to the scope of the present invention. Wherein, the light-pervious substrate 51 is formed with two wire holes 53 for being respectively allow wires 54, 55 connected to the first metal pin 31 and the second metal pin 32 to pass then to be directly soldered on the light-pervious substrate 51. In addition, the light-pervious substrate 51 is formed with at least a third lock hole 56 corresponding to the second connection hole 43, so at least a screw 57 can be provided for passing the third lock hole 56 for locking the light-pervious substrate 51 on the support post 40.

The light-pervious substrate 51 is a transparent or translucent substrate, e.g. but not limited to a glass substrate, sapphire substrate or indium tin oxide (ITO) substrate. The periphery and the top of the lighting unit 52 and the backside of the light-pervious substrate 51 defined at the lighting unit 52 and the periphery of the lighting unit 52 can be further provided with a phosphor coating 59, thereby allowing the top, the bottom and the periphery of the LED chip 52 to be respectively covered by the fluorescent powders 59. As such, when the lighting unit 52 is supplied with electric power, the fluorescent powders 59 are able to convert the emitted blue light into white light or yellow light so as to be outputted through the lampshade 60. What shall be addressed is that the quantity of the lighting unit 52 is determined according to actual needs.

The lampshade 60 is configured to transmit light originating from the light source module 50, and preferably mounted on the insulation part 20. The lampshade 60 is formed as a light-pervious lampshade and preferably made of a glass material.

As shown in FIG. 3, when being assembled, the insulation part 20 is firstly screw-fitted with the bulb base 10, then the power module 30 is disposed in the insulation part 20 through the side strips 33 being slid and received in the slide grooves 25; the pad 35 is fastened on the insulation part 20; the support post 40 is disposed on the pad 35; the light source module 50 is fastened on top of the support post 40 thereby allowing the wires 54, 55 to respectively pass the wire holes 53; solder is used for respectively soldering the wires 54, 55 on the light-pervious substrate 51; the screws 57 are provided for locking the light source module 50 on the support post 40; lastly the lampshade 60 is combined with the insulation part 20 thereby finishing the assembly of the present invention. Accordingly, the assembly of the LED light bulb provided by the present invention is very easy, and excellent heat dissipation and light outputting in 360 degrees are achieved; as such, the LED light bulb provided by the present invention is novel comparing with the LED light bulb disclosed in the China Patent Application NO. CN103016991A.

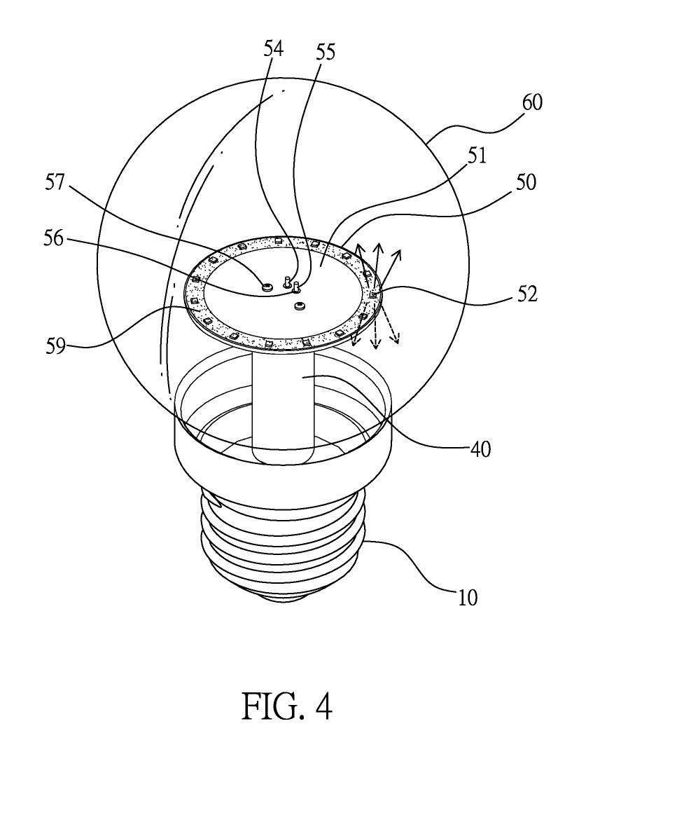

Referring to FIG. 4, which is a schematic view illustrating the omnidirectional output of the LED light bulb according to one preferred embodiment of the present invention. As shown in FIG. 4, when the LED light bulb provided by the present invention is supplied with electric power, the blue light emitted by the plural lighting units 52 arranged at the outer side of the light-pervious substrate 51 can be converted into white light or yellow light by the fluorescent powders 59 provided at the peripheries and the tops of the plural lighting units 52 and the backside of the light-pervious substrate 51 defined at the lighting units 52 and the periphery of the lighting unit 52 so as to be outputted, as such, the light can not only be emitted from the top side of the light-pervious substrate 51, but also can be emitted from the bottom side of the light-pervious substrate 51, thereby achieving the omnidirectional output.

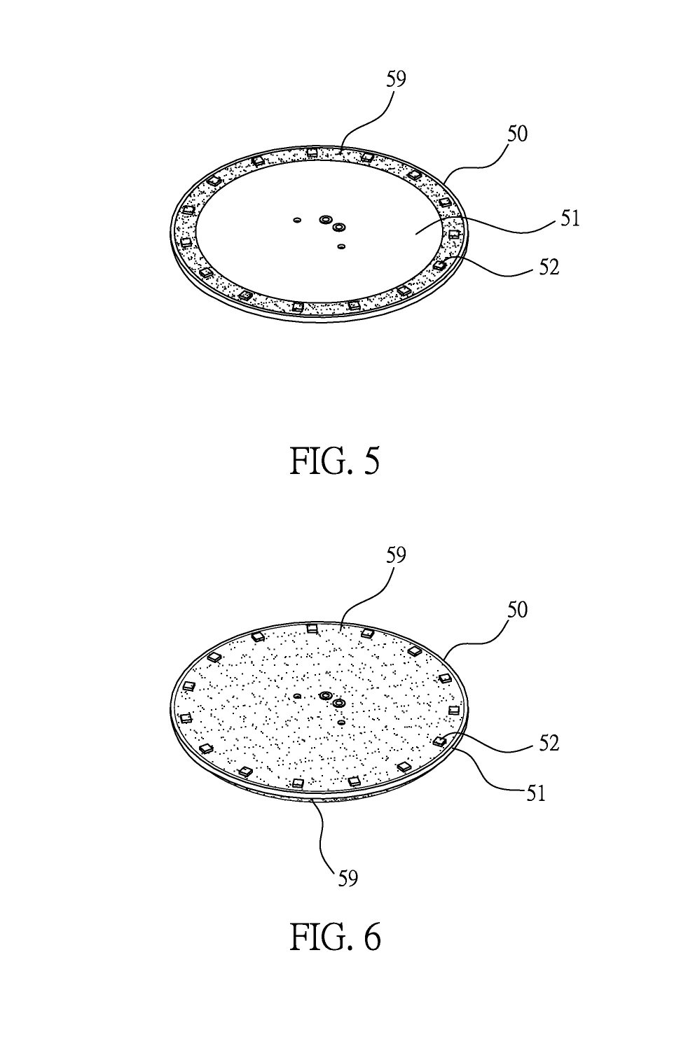

Referring to FIG. 5, which is a perspective view illustrating the LED light bulb according to one preferred embodiment of the present invention. As shown in FIG. 5, the light source module 50 includes a light-pervious substrate 51 and plural lighting units 52, wherein the lighting unit 52 is e.g. but not limited to a LED chip and preferably to be a chip on board (COB) LED unit and annularly arranged at the outer side of the light-pervious substrate 51, moreover, the periphery and the top of the lighting unit 52 and the backside of the light-pervious substrate 51 defined at the lighting units 52 and the periphery of the lighting unit 52 can be further provided with a phosphor coating 59, thereby allowing the top, the bottom and the periphery of the LED unit 52 to be respectively covered by the phosphor coating 59.

Referring to FIG. 6, which is a perspective view illustrating the LED light bulb according to another preferred embodiment of the present invention. As shown in FIG. 6, the light source module 50 includes a light-pervious substrate 51 and plural lighting units 52, wherein the lighting units 52 are e.g. but not limited to be annularly arranged at the outer side of the light-pervious substrate 51, moreover, the top surface, the bottom surface and the lateral side of the light-pervious substrate 51 are further provided with a phosphor coating 59, thereby allowing the top, the bottom and the periphery of the LED unit 52 to be respectively covered by the fluorescent powders 59, so the blue light emitted by the lighting unit 52 can be prevented from being outputted from the location where the phosphor coating 59 not being provided.

Based on what has been disclosed above, in the LED light bulb provided by the present invention, the light source module is disposed on top of the support post, and the light source module includes a substrate and a chip on board (COB) LED unit, the COB LED unit is annularly arranged at the outer side of the substrate, and the periphery and the top of the lighting unit and the backside of the light-pervious substrate defined at the lighting unit and the periphery of the lighting unit are further provided with a phosphor coating, thereby achieving the omnidirectional output.

Accordingly, the LED light bulb provided by the present invention is novel and practical in use comparing to prior art.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

What is claimed is:

1. A LED light bulb, including:
a bulb base;
an insulation part, disposed on said bulb base and formed with an accommodation space;
a power module, disposed in said accommodation space and electrically connected to said bulb base;
a support post, disposed on said insulation part;
a light source module, disposed on top of said support post and electrically connected to said power module, and including a light-pervious substrate and plural lighting units, the periphery and the top of said lighting unit and the backside of said light-pervious substrate defined at said lighting unit and the periphery of said lighting unit are further provided with a phosphor coating; and
a lampshade, configured to transmit light originating from said light source module .

2. The LED light bulb as claimed in claim 1, wherein the top surface, the bottom surface and the lateral side of said light-pervious substrate are further provided with a phosphor coating.

3. The LED light bulb as claimed in claim 1, wherein said plural lighting units are annularly arranged at the outer side of said light-pervious substrate.

4. The LED light bulb as claimed in claim 2, wherein said plural lighting units are annularly arranged at the outer side of said light-pervious substrate.

5. The LED light bulb as claimed in claim 2, wherein said lampshade is a light-pervious lampshade.

6. The LED light bulb as claimed in claim 2, wherein said light-pervious substrate is a transparent or translucent substrate.

7. The LED light bulb as claimed in claim 2, wherein said light-pervious substrate is a glass substrate, a sapphire substrate or an indium tin oxide (ITO) substrate.

8. The LED light bulb as claimed in claim 2, wherein said support post is a metal support post.

9. The LED light bulb as claimed in claim 2, wherein said lighting unit is a LED chip.

10. The LED light bulb as claimed in claim 9, wherein said LED chip is a blue LED chip.

11. The LED light bulb as claimed in claim 2, wherein said lighting unit is a chip on board (COB) LED unit.
